(19) United States
(12) Patent Application Publication
(10) Pub. No.: US 2024/0045449 A1
(43) Pub. Date: Feb. 8, 2024

(54) METHOD FOR CONTROLLING A DRONE ALONG A SHAFT

(71) Applicant: Inventio AG, Hergiswil (CH)

(72) Inventors: Raphael Bitzi, Luzern (CH); Christian Studer, Kriens (CH)

(21) Appl. No.: 18/254,886

(22) PCT Filed: Nov. 24, 2021
(86) PCT No.: PCT/EP2021/082813

§ 371 Date: May 30, 2023

(30) Foreign Application Priority Data
Dec. 3, 2020 (EP) 20211465.8

(51) Int. Cl. G05D 1/10

(52) U.S. Cl. CPC G05D 1/102; B64U 10/14

(57) ABSTRACT

A method controls a drone along a shaft having adjoining first and second shaft walls. A drone sensor system detects an environment and/or a state of flight, an actuator system controls the drone, and a control device controls the actuator system. Method steps include: control device receiving sensor data generated by sensor system; determining actual distances of drone relative to first and second shaft walls from sensor data; and generating control signal actuating actuator system such that drone flies based on deviation of actual distances from target distances and a target flight route to a target position. An actual flight route is determined from the sensor data, and the control signal is generated based on a deviation of the actual flight route from the target flight route. Door regions and/or height markings in the shaft are recognized from the sensor data to determine the actual flight route.

### FIELD

The present invention relates to a method for controlling a drone along a shaft. Furthermore, the invention relates to a control device, a computer program and a computer-readable medium for carrying out the method mentioned. Furthermore, the invention relates to a drone control system comprising a control device of this kind, and an elevator installation comprising at least one drone which is equipped with such a drone control system.

### BACKGROUND

A drone, for example in the form of a quadrocopter, can be equipped, for example, with a satellite-based navigation system, which enables partially or fully automated control of the drone. Under certain conditions, however, the reception of the satellite signal may be restricted, for example when the drone is flying within buildings. Indoor drones, which are particularly suitable for use in buildings, can therefore be equipped with an image sensor system for detecting their environment. Often, the environment in which such an indoor drone is to fly is not known in advance. For navigation, a digital map can therefore be generated from the images of the image sensor system, for example. For this purpose, relatively complex image processing algorithms are generally required.

Drones can be used for example for camera-assisted inspection of industrial plants or shafts. An example of a drone equipped with a camera for inspecting a shaft is described in EP 3 489 184 A1. In this case, the drone is mechanically guided when flying along the shaft by a mechanical guide device extending vertically along the shaft.

JP 2017 226259 A and EP 3 739 420 A1 describe methods for controlling a drone along a shaft, in which the drones fly at a definable distance from a shaft wall.

JP 2017 128440 A describes a method for controlling a drone along an elevator shaft to inspect the elevator shaft.

### SUMMARY

There may be a need for a method for controlling a drone along a shaft, by means of which the drone can be controlled in a partially or fully automated manner along the shaft without additional mechanical guides and/or using comparatively simple control electronics. As a result, the costs for providing such a drone can be significantly reduced.

Control electronics simplified in this way also offer the advantage of increased robustness. Furthermore, there may be a need for a control device, a computer program product and a computer-readable medium for carrying out the method, for a drone control system configured with such a control device, and for an elevator installation configured with such a drone control system.

Such a need can be met by the subject matter of any of the advantageous embodiments defined in the following description.

A first aspect of the invention relates to a method for controlling a drone along a shaft. The shaft has at least a first shaft wall and a second shaft wall adjoining the first shaft wall. The drone has a sensor system for detecting an environment and/or a state of flight of the drone, an actuator system for controlling the drone, and a control device for controlling the actuator system. The method comprises at least the following steps: receiving sensor data which have been generated by the sensor system, in the control device; determining actual distances of the drone relative to the first shaft wall and to the second shaft wall by processing the sensor data; and generating a control signal for actuating the actuator system such that the drone flies along the shaft, on the basis of a deviation of the actual distances from the target distances and a target flight route which the drone is to cover until reaching a target position in the shaft. An actual flight route of the drone is determined by processing the sensor data. The control signal is generated on the basis of a deviation of the actual flight route from the target flight route.

According to the invention, door regions and/or height markings in the shaft are recognized by processing the sensor data. The actual flight route is determined on the basis of the door regions and/or height markings recognized by processing the sensor data.

The door regions and/or height markings can be recognized, for example, by processing image data of the environment of the drone generated by the sensor system. This embodiment makes it possible, for example, to reliably detect the actual flight altitude of the drone, even in the case of fluctuating ambient pressure.

The method can, for example, be automatically executed by a processor of the control device of the drone.

The modules of the control device mentioned here and below can be implemented as software and/or hardware.

A drone can be understood to mean an unmanned aircraft, for example in the form of a multicopter. However, other designs of the drone are also possible. The drone can be equipped with control software for partially or fully automated actuation of the actuator system on the basis of the sensor data. The control software can be stored in a memory of the control device and executed by the processor of the control device.

The shaft can be, for example, an elevator shaft, ventilation shaft or cable shaft. The shaft can extend vertically, horizontally and/or obliquely. The arrangement or orientation of the sensor system is adapted to the course of the shaft. A target flight route can be understood to mean the length of a path to be traveled by the drone to the target position. The target position can, for example, be a reversal position at which the direction of movement of the drone is to be reversed, for example in order to move the drone back to an initial position. In the case of a vertical shaft, the target flight route can, for example, be a target flight altitude which the drone is intended to reach as a maximum, or reaching a marking.

The first shaft wall and the second shaft wall can be regarded as elongate side walls of the shaft which come together at their respective longitudinal edge. For example, the first shaft wall and the second shaft wall can be oriented orthogonally to one another. In addition, the shaft can have a floor, a ceiling, a third shaft wall and/or a fourth shaft wall. It is possible for at least one of the shaft walls to have one or more openings, for example ventilation or door openings or other access openings.

The sensor system can have at least one environment sensor such as a camera, a LIDAR, ultrasonic or radar sensor, and/or at least one flight dynamics sensor such as an acceleration or rotation rate sensor, for example in the form of an inertial measuring unit. Furthermore, the sensor system can comprise an air pressure sensor for altitude measurement. Even if it is not necessary for the execution of the method according to the invention, the sensor system can additionally have a location sensor for determining a geographical position of the drone using a global navigation satellite system such as GPS, GLONASS or the like.

The flight dynamics data generated by the flight dynamics sensor can be used, for example, as input data for stability control for stabilizing the state of flight of the drone. The distance-based or flight-route-based control of the drone can be overlaid by the stability control.

For example, the sensor system for determining the actual distances can comprise a 2D distance sensor in the form of a LIDAR sensor. The LIDAR sensor can comprise, for example, laser optics rotatable about 360 degrees for scanning the environment of the drone. In this case, a rotational plane of the laser optics can be oriented perpendicularly or obliquely to a wall surface of the first shaft wall and/or the second shaft wall. An oblique orientation has the advantage that, in addition to the actual distances relative to the first and second shaft wall, an actual distance relative to a floor and/or a ceiling of the shaft can be determined from the sensor data, without a plurality of sensors being required for this purpose.

Alternatively, the sensor system for determining the actual distances can comprise a plurality of 1D distance sensors, for example in the form of ultrasonic sensors or LIDAR sensors. However, a combination of a 2D distance sensor with one or more 1D distance sensors is also possible.

The target distances may have been selected for example taking into account a given width and/or depth of the shaft. Likewise, for example, the target flight route may have been selected taking into account a given height or length of the shaft. It is possible that the target distances or the target flight route are or is input into the control software of the drone via a corresponding user interface, by a user of the drone. However, an automatic setting of the target distances or the target flight route, for example on the basis of a geographical position of the drone, is also possible. The target flight route can also be indicated by a marking in the shaft, in particular the mentioned marking can be the target or reversal position. The marking can be optically recognized by the sensor system, for example.

For example, it is possible for the target distances or the target flight route to be determined on the basis of geometry data which define a given geometry of the shaft, for example its width, depth and/or length.

The geometry data can be received, for example, in the control device from an external data storage device for storing different geometry data with respect to different shafts. The external data storage device can be, for example, a central server, a PC, a laptop, a Smartphone, a tablet or another mobile terminal. In this case, the geometry data can be provided to the control device via a wired or wireless data connection, for example via a WLAN, Bluetooth or mobile radio connection. Alternatively, the different geometry data can also be stored in the memory of the control device.

It is noted that it is not absolutely necessary, for controlling the drone along the shaft, to determine an actual flight route of the drone, for example an actual flight altitude. Compliance with the target flight route can also be ensured, for example, by controlling the drone along the shaft in accordance with a speed profile predefined depending on the target flight route. For example, different predefined speed profiles for different target flight routes can be stored in the control device. Alternatively, the speed profile can be calculated depending on the target flight route, using a corresponding mathematical function. It is also possible for the drone to be remote-controlled by a human operator who adjusts the flight altitude, the speed and/or the orientation of the drone, and only the distances from the shaft walls to be set automatically. In addition, collisions with the floor and the ceiling of the shaft can be automatically prevented. This can be referred to as semi-automatic operation.

The actuator system can be configured to change the position and/or orientation of the drone in three-dimensional space. For this purpose, the actuator system can comprise one or more rotors and one or more drive motors for driving the rotor or rotors. In addition, the actuator system can comprise one or more servomotors, for example for changing the orientation of the rotors. The rotors can be arranged, for example, in the same rotational plane. However, other drive configurations are also possible.

The actual flight route can be determined, for example, as an actual flight altitude on the basis of an actual distance of the drone relative to a floor and/or a ceiling of the shaft. However, the actual flight altitude can also be determined from sensor data of an air pressure sensor of the drone. This embodiment also makes it possible to reliably prevent the drone from flying beyond the target position when flying along the shaft.

In short, the approach presented here enables the control of a drone along a shaft with minimal hardware and/or software complexity, in that, at a given target position of the drone, only its distance from two adjacent shaft walls needs to be detected and evaluated. The complex creation of a digital map of the environment of the drone during flight operation can thus be dispensed with or can be completed by an onboard measuring system. In contrast to common indoor drones, which are generally equipped with an extensive sensor system and correspondingly complex control electronics, the costs for a drone simplified in this way can be significantly lower.

A second aspect of the invention relates to a control device having a processor configured to carry out the method according to an embodiment of the first aspect of the invention. As mentioned further above, the control device can comprise hardware and/or software modules. In addition to the processor, the control device may comprise a memory and data communication interfaces for data communication with peripheral devices. Features of the method according to an embodiment of the first aspect of the invention can also be features of the control device, and vice versa.

A third aspect of the invention relates to a drone control system for actuating an actuator system of a drone. The drone control system comprises a sensor system for detecting an environment and/or a state of flight of a drone, and a control device according to an embodiment of the second aspect of the invention. Features of the method according to an embodiment of the first aspect of the invention can also be features of the drone control system, and vice versa.

A fourth aspect of the invention relates to an elevator installation, for example a goods or passenger elevator. The elevator installation comprises at least one elevator shaft which has at least a first shaft wall and a second shaft wall adjoining the first shaft wall, and at least one drone to be controlled along the elevator shaft, which drone is equipped with an actuator system for controlling the drone, and a drone control system for actuating the drone according to an embodiment of the third aspect of the invention. By means of the drone or the drones, it is possible, for example, to measure and/or inspect the elevator shaft, in particular before installation of elements of the elevator installation, for example of guide rails or elevator cars, in the elevator shaft. Furthermore, the drone or the drones can be configured to transport loads through the elevator shaft, for example to receive and/or deposit them in an automated manner in the elevator shaft.

A fifth aspect of the invention relates to a computer program. The computer program comprises commands which cause a processor to carry out the method according to an embodiment of the first aspect of the invention when the computer program is executed by the processor.

A sixth aspect of the invention relates to a computer-readable medium on which the computer program according to an embodiment of the fifth aspect of the invention is stored. The computer-readable medium can be a volatile or non-volatile data memory. For example, the computer-readable medium may be a hard disk, a USB memory device, a RAM, ROM, EPROM, or flash memory. The computer-readable medium can also be a data communication network that enables a program code to be downloaded, such as the Internet or a data cloud.

Features of the method according to an embodiment of the first aspect of the invention can also be features of the computer program and/or of the computer-readable medium, and vice versa.

Possible features and advantages of embodiments of the invention can be considered, inter alia and without limiting the invention, to be based upon the concepts and findings described below.

According to one embodiment, the actual distances comprise a first actual distance of the drone relative to the first shaft wall in a first spatial direction, and a second actual distance of the drone relative to the second shaft wall in a second spatial direction orthogonal to the first spatial direction. In this case, the control signal is generated on the basis of a deviation of the first actual distance from a first target distance, and a deviation of the second actual distance from a second target distance.

The first spatial direction can correspond, for example, to a width direction of the shaft. The second spatial direction can correspond, for example, to a depth direction of the shaft. In this case, the control signal can be generated in order to control the drone in the vertical or longitudinal direction of the shaft. The first actual distance and the second actual distance may have been detected, for example, by a 1D distance sensor, for example in the form of an ultrasonic sensor. As already mentioned above, however, the use of a 2D distance sensor, for example in the form of a LIDAR sensor, is also possible for detecting the first and second actual distances. The control signal can be generated in such a way that the deviation of the actual distances from the target distances is as small as possible and/or the actual distances are as constant as possible. The first target distance and the second target distance may be the same or different. By means of this embodiment, it is possible to prevent, by simple means, the drone from coming into contact with the shaft walls when flying along the shaft. For example, the first target distance and the second target distance can be selected such that the drone flies as centrally as possible in the shaft. However, the first target distance and the second target distance can also be selected differently, as desired. It is also possible for the target distances to be changed during flight of the drone. This can take place, for example, depending on the flight altitude, the detection of markings in the shaft, or manually by a human operator.

According to one embodiment, the actual distances comprise an additional first actual distance of the drone relative to the first shaft wall in the first spatial direction. In this case, the first actual distance and the additional first actual distance are associated with different points of the first shaft wall. On the basis of the first actual distance and the additional first actual distance, an actual orientation of the drone is determined. In this case, the control signal is further generated on the basis of a deviation of the actual orientation from a target orientation. For example, to detect the first actual distance and the additional first actual distance, the drone can have two 1 D distance sensors arranged next to one another at a defined spacing. By means of this embodiment, the actual orientation of the drone, for example its yaw angle, can be determined very easily by calculating a difference between the first actual distance and the additional first actual distance. The described determination of the actual orientation of the drone can be determined analogously from measurement data of a 2D sensor.

According to one embodiment, a third actual distance of the drone relative to a ceiling of the shaft is further determined by processing the sensor data. In this case, the control signal is further generated on the basis of a deviation of the third actual distance from a third target distance. The target flight route can be defined, for example, by the third target distance. The third actual distance can be detected, for example, by means of a 1 D distance sensor or a 2D distance sensor that is possibly oriented obliquely to the ceiling. It is thus possible to ensure, by simple means, that the drone does not fly beyond the target position. The third target distance can be selected such that the drone is prevented from coming into contact with the ceiling or approaching too close to the ceiling. Thus, damage to the drone while flying along the shaft can be avoided.

According to one embodiment, a fourth actual distance of the drone relative to a floor of the shaft is further determined by processing the sensor data. In this case, the control signal is further generated on the basis of a deviation of the fourth actual distance from a fourth target distance. The target flight route can be defined, for example, by the fourth target distance. The fourth actual distance can be detected, for example, by means of a 1 D distance sensor or a 2D distance sensor that is possibly oriented obliquely to the ground. It is thus possible to ensure, by simple means, that the drone does not fly beyond the target position. A safe landing of the drone on the floor of the shaft can thus also be ensured.

The drone can be located, for example, on the floor of the shaft, in an initial position. For example, the drone can be placed, in the initial position, centrally between the first and second shaft wall or offset with respect to the center between the first and second shaft wall, on the floor of the shaft. The control signal can be generated, for example, in such a way that the drone located in the initial position lifts off from the floor of the shaft, flies as far as the target position, flies from there back to the floor of the shaft, and finally lands on the floor of the shaft. By means of the described positioning of the drone on the floor of the shaft, the target distances from the shaft walls and a target orientation of the drone are determined or fixed.

According to one embodiment, the method further comprises a step of generating measurement data, comprising a measured width, depth and/or length of the shaft, from the sensor data. For this purpose, the sensor data can be filtered and/or transformed in a suitable manner by the control device. The measurement data can comprise, for example, coordinates of a plurality of measurement points which maps a geometry of the shaft in a three-dimensional coordinate system. This embodiment thus enables an automated measurement of the shaft.

According to one embodiment, the method further comprises a step of transmitting the sensor data and/or data generated from the sensor data from the control device to an external data processing device. The sensor data transmitted by the control device can comprise, for example, image data of the shaft. The data generated from the sensor data can be, for example, data generated by filtering and/or transformation of the sensor data, for example measurement data. The transmission can take place, for example, during flight operation of the drone. An external evaluation of the sensor data and/or of the data generated from the sensor data is thus made possible. This has the advantage that the hardware and/or software of the control unit can be kept very simple. For example, the external data processing device can be configured to generate the geometry data (see further above) from the sensor data and/or the data generated from the sensor data.

According to one embodiment, the sensor system comprises an ultrasonic sensor system and/or a laser sensor system for detecting the environment of the drone. Additionally or alternatively, the sensor system can comprise an acceleration sensor system for detecting the state of flight of the drone. The acceleration sensor system can comprise, for example, an inertial measurement unit or a gyroscope sensor. For example, the production costs of the drone can be greatly reduced by the omission of cameras and satellite-based locating of the drone.

Embodiments of the invention will be described below with reference to the accompanying drawings, neither the drawings nor the description being intended to be interpreted as limiting the invention.

### DESCRIPTION OF THE DRAWINGS

FIG. 1 is a schematic view of a drone comprising a drone control system according to an embodiment of the invention, in a shaft.

FIG. 2 is an enlarged schematic view of a drone control system according to an embodiment of the invention.

FIG. 3 is a schematic view of an elevator installation according to an embodiment of the invention.

FIG. 4 is a cross-sectional view of an elevator shaft from FIG. 3.

The drawings are merely schematic, and not to scale. In the different figures, identical reference signs denote identical or similar features.

### DETAILED DESCRIPTION

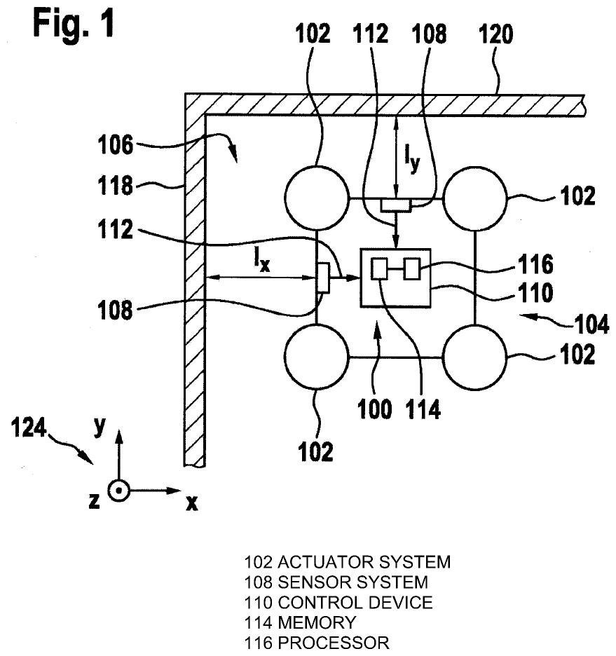

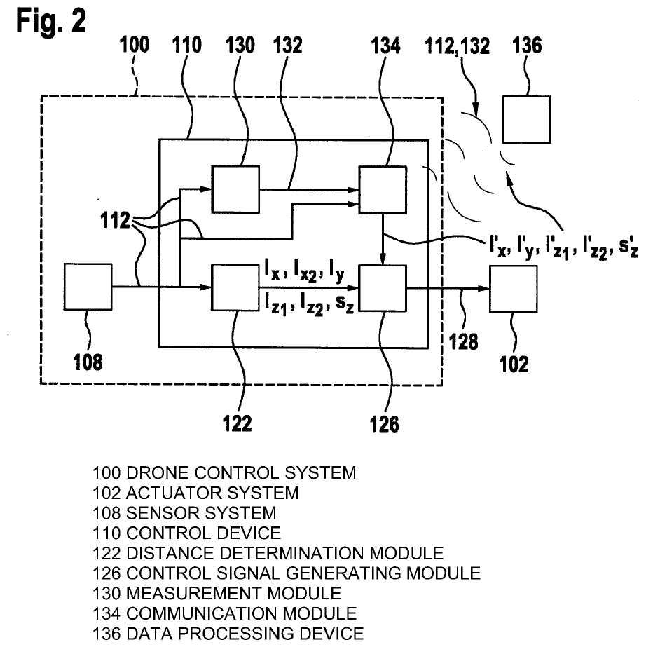

FIG. 1 and FIG. 2 show a drone control system 100 for actuating an actuator system 102 of a drone 104, here by way of example of a quadrocopter, the actuator system 102 of which comprises four propeller units which can be actuated separately from one another. The drone 104 is located in a shaft 106, for example an elevator, ventilation or cable shaft. The drone control system 100 is configured to actuate the actuator system 102 such that the drone 104 flies along the shaft 106, i.e. in the longitudinal direction of the shaft 106.

For this purpose, the drone control system 100 comprises a sensor system 108 for detecting an environment and/or a state of flight of the drone 104, as well as a control device 110 for actuating the actuator system 102 on the basis of sensor data 112 which are generated by the sensor system 108 during detection of the environment and/or the state of flight of the drone 104.

The modules of the control device 110 described below may be stored in the form of a corresponding computer program in a memory 114 of the control device 110 and executed by executing the computer program by a processor 116 of the control device 110 (see FIG. 1). However, it is also possible for the modules to be implemented as hardware.

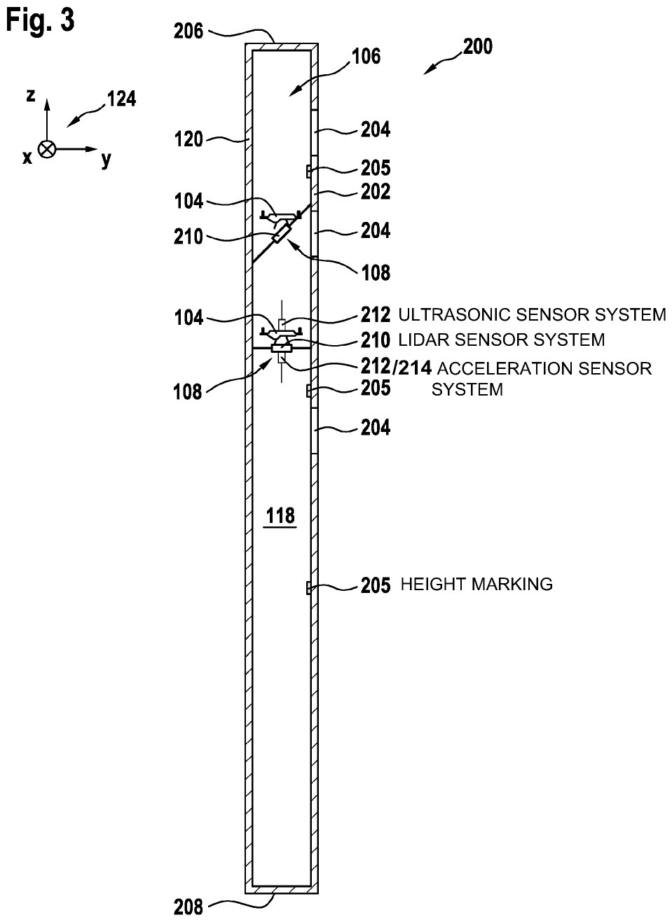

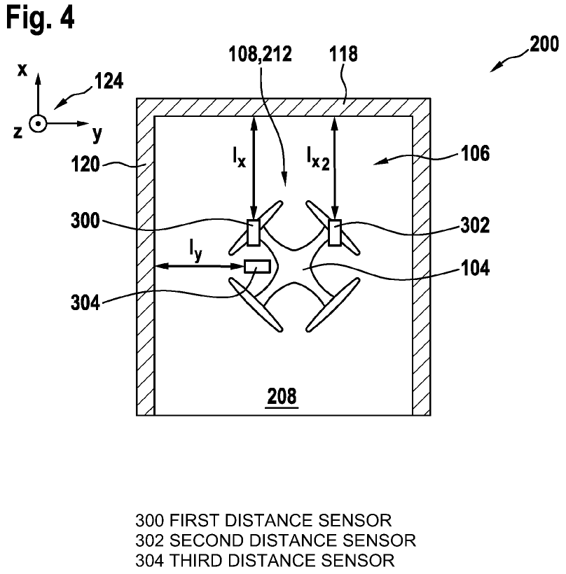

In this example, the shaft 106 comprises two side walls in the form of a first shaft wall 118 and a second shaft wall 120, which adjoin one another at their longitudinal edges. Here, the first shaft wall 118 and the second shaft wall 120 are oriented perpendicularly to one another by way of example. It is possible for the shaft 106 to comprise further side walls, a floor and/or a ceiling (see also FIG. 3 and FIG. 4).

In order to control the drone 104 along the shaft 106, the sensor data 112 are input into a distance determination module 122 of the control device 110 (see FIG. 2) which is configured to determine actual distances of the drone 104 relative to the first shaft wall 118 and to the second shaft wall 120, from the sensor data 112. In this example, the distance determination module 122 determines the actual distances in a three-dimensional x, y, z coordinate system 124. In this case, a first actual distance lₓ relative to the first shaft wall 118 in the direction of an x-axis of the coordinate system 124, and a second actual distance l_{y} relative to the second shaft wall 120 in the direction of a y-axis of the coordinate system 124 are determined.

The actual distances lₓ, l_{y} are subsequently input into a control signal generating module 126 of the control device 110 which is configured to generate a control signal 128 for actuating the actuator system 102, from the actual distances lₓ, l_{y}, target distances lₓ′, l_{y}′ associated with the actual distances lₓ, l_{y}, and a target flight route s_{z}′ which the drone 104 is intended to travel, while flying along the shaft 106, i.e. in the z-direction, until reaching a target position. The control signal 128 causes the actuator system 102 to control the drone 104 in such a way that it moves in the z-direction in the shaft 106, taking into account the target flight route s_{z}′ and the target distances lₓ′, l_{y}′. For this purpose, the control signal generating module 126 determines a deviation of the first actual distance lₓ from a first target distance lₓ′, and a deviation of the second actual distance l_{y} from a second target distance l_{y}′, and generates the control signal 128 on the basis of these deviations.

In addition, the distance determination module 122 may be configured to determine a third actual distance l_{z}_{₁} relative to a ceiling 206 (see FIG. 3) of the shaft 106 and/or a fourth actual distance l_{z}_{₂} relative to a floor 208 (see FIG. 3 and FIG. 4) of the shaft 106, in the direction of a z-axis of the coordinate system 124, by processing the sensor data 112. Accordingly, the control signal generating module 126 may be configured to additionally generate the control signal 128 on the basis of the third actual distance l_{z}_{₁} and/or the fourth actual distance l_{z}_{₂}, for instance on the basis of a deviation of the third actual distance l_{z}_{₁} from a third target distance l_{z}_{₁}′ and/or a deviation of the fourth actual distance l_{z}_{₂} from a fourth target distance l_{z}_{₂}′.

It is also possible, for example, that, by processing the sensor data 112 in the distance determination module 122, an actual flight route s_{z} of the drone 104, i.e. a path traveled by the drone 104 in the z direction, or a current altitude of the drone 104 in the shaft 106 is determined. In this case, the control signal generating module 126 may be configured to additionally generate the control signal 128 on the basis of the actual flight route s_{z}, more precisely on the basis of a deviation of the actual flight route s_{z} from the target flight route s_{z}′.

In addition, the control device 110 can comprise a measurement module 130 for converting the sensor data 112 into measurement data 132, for example by means of corresponding filtering and/or transformation of the sensor data 112. The measurement data 132 can indicate a measured geometry of the shaft 106 in the coordinate system 124, for example its width, depth and/or length or height.

It is further possible that the sensor data 112 and/or data generated from the sensor data 112, such as the measurement data 132, are sent to an external data processing device 136 via a communication module 134 of the control device 110 for external storage and/or further processing, here, by way of example, via a wireless data communication connection such as WLAN, Bluetooth, mobile radio or the like. The external data processing device 136 may, for example, be a server, PC, laptop, Smartphone, tablet or the like.

Alternatively or additionally, it is possible that the communication module 134 receives data from the external data processing device 136. The data can, for example, be values for the target distances lₓ′, l_{y}′, l_{z}_{₁}′, and/or l_{z}_{₂}′, and/or the target flight route s′ or geometry data relating to the shaft 106, from which these values are to be generated.

FIG. 3 shows parts of an elevator installation 200. In this example, the shaft 106 is a vertical elevator shaft 106 of the elevator installation 200. In this case, a third shaft wall 202 of the elevator shaft 106 opposite the second shaft wall 120 has a plurality of door regions 204 each having a door opening via which the elevator shaft 106 is accessible from the outside, for example from different floors of a building. For example, the distance determination module 122 may be configured to determine the actual flight route s_{z}, which here corresponds to an actual flight altitude of the drone 104, by recognizing the door regions 204 in the sensor data 112. A ceiling 206 and a floor 208 of the elevator shaft 106 are also shown.

Height markings 205, which indicate defined positions or heights in the elevator shaft 106, can be arranged in or on the elevator shaft 106. These can be, for example, what are known as cutting checks. For example, the distance determination module 122 may be configured to determine the actual flight route s_{z}, which here corresponds to an actual flight altitude of the drone 104, by recognizing the height markings 205 in the sensor data 112.

The elevator installation 200 further comprises the drone 104, or also a plurality thereof, equipped with the drone control system 100 and the actuator system 102. For example, the drone 104 can be moved up and down along the elevator shaft 106 in order to inspect the interior of the elevator shaft 106 and/or to carry out an automated measurement of the elevator shaft 106, as already mentioned further above.

In addition, FIG. 3 shows two configurations, by way of example, of the sensor system 108 for detecting the environment of the drone 104.

An upper one of the two configurations comprises a LIDAR sensor system 210 as a 2D distance sensor. The LIDAR sensor system 210 is configured in this example to detect distances in one or more oblique planes. In this case, “oblique plane” means a plane that intersects all three planes of the coordinate system 124. For example, the LIDAR sensor system 210 can be arranged on the drone 104 in such a way that, during flight operation of the drone 104, it is oriented diagonally to a vertical, in this case to the z-axis. A detection angle of the LIDAR sensor system 210 can be between 90 and 360 degrees, for example. It is thus possible to simultaneously detect distances from the shaft walls 118, 120, 202 to the ceiling 206 and to the floor 208.

A lower one of the two configurations comprises, in addition to the LIDAR sensor system 210 as a 2D distance sensor, an ultrasonic sensor system 212 having two 1 D distance sensors pointing in opposite directions for detecting distances from the ceiling 206 or from the floor 208. In this configuration, the LIDAR sensor system 210 is configured to detect distances in one or more planes in parallel with the x, y-plane.

Another possible configuration of the ultrasonic sensor system 212 is shown in FIG. 4. In this example, the ultrasonic sensor system 212 comprises a first 1D distance sensor 300 for detecting the first actual distance lₓ, a second 1D distance sensor 302 for detecting an additional first actual distance lₓ_{₂} relative to the first shaft wall 118 in the x-direction, and a third 1D distance sensor 304 for detecting the second actual distance l_{y}. As can be seen in FIG. 4, the first actual distance lₓ and the additional first actual distance lₓ_{₂} are associated with different points of the first shaft wall 118. Accordingly, the control signal generating module 126 can be configured to determine an actual orientation of the drone 104, such as a yaw angle with respect to the z-axis, on the basis of the first actual distance G and the additional first actual distance lₓ_{₂}, and to generate the control signal 128 on the basis of a deviation of the actual orientation from a corresponding target orientation.

For controlling the drone 104 in the elevator shaft 106, the control device 110 can, for example, comprise a horizontal controller for controlling the distance of the drone 104 from the two shaft walls 118, 120, and a speed controller for controlling a vertical speed of the drone 104 taking into account the target flight route s_{z}′. In this case, the vertical speed can initially be kept constant and can be reduced shortly before reaching the target position, i.e. shortly before reaching the end of the elevator shaft 106.

The vertical speed can be defined, for example, as a fixed advancement. An actual speed of the drone 104 can be determined for example by integrating acceleration values of an acceleration sensor system 214 (FIG. 3), by deriving altitude values of an altitude sensor, for example in the form of an air pressure sensor, or incrementally by evaluating camera images contained in the sensor data 112.

A sequence, by way of example, of a flight maneuver of the drone 104 is described below.
1. The drone 104 is positioned and oriented on the floor 208.
2. The horizontal controller is reset to zero or initialized.
3. The drone 104 flies upward, i.e. in the direction of the ceiling 206, along the elevator shaft 106 at a constant vertical speed.
4. The ceiling 206 is detected by the sensor system 108. Accordingly, the vertical speed is reduced until the drone 104 reaches a standstill in the air. Subsequently, the drone 104 flies back in the direction of the floor 208.
5. The floor 208 is detected by the sensor system 108. Accordingly, the vertical speed is reduced until standstill of the drone 104 in the air or at least reduced to such an extent that the drone 104 moves very slowly to the floor 208. Subsequently, the drone 104 lands gently on the floor 208.

For the distance measurement, stereo cameras, depth cameras, tracking sensors and/or time-of-flight sensors can alternatively or additionally be used.

It is possible that the position of the drone 104 in the elevator shaft 106 is determined on the basis of visual odometry, optionally assisted by an inertial measurement unit. A change in position with respect to a reference position of the drone 104, for example its initial position on the floor 208, can then be calculated by means of temporal tracking of features recognized in the sensor data 112, for example the door regions 204 or special height markings 205 in the elevator shaft 106, or on the basis of an optical flow.

In addition or as an alternative to the method described with reference to FIG. 1, FIG. 2, FIG. 3 and FIG. 4 for (automated) control of the drone 104, the drone 104 can be remotely controllable by a human operator. In this case, the human operator adjusts the flight altitude, the speed and/or the orientation of the drone, and the distances to the shaft walls are set automatically. In addition, collisions with the floor and the ceiling of the shaft can be automatically prevented. This can be referred to as semi-automatic operation.

Finally, it should be noted that terms such as “comprising,” “including,” etc. do not exclude other elements or steps, and terms such as “a” or “an” do not exclude a plurality. Furthermore, it should be noted that features or steps that have been described with reference to one of the above embodiments can also be used in combination with other features or steps of other embodiments described above.

In accordance with the provisions of the patent statutes, the present invention has been described in what is considered to represent its preferred embodiment. However, it should be noted that the invention can be practiced otherwise than as specifically illustrated and described without departing from its spirit or scope.

1-13. (canceled)

14. A method for controlling a drone along a shaft, the shaft having adjoining first and second shaft walls, the drone having a sensor system for detecting an environment and/or a state of flight of the drone, the drone having an actuator system for controlling the drone in flight, and the drone having a control device for controlling the actuator system, the method comprising the steps of:
receiving in the control device sensor data generated by the sensor system;
determining actual distances of the drone relative to the first shaft wall and to the second shaft wall by processing the sensor data;
generating a control signal actuating the actuator system such that the drone flies along the shaft based on a deviation of the actual distances from predetermined target distances and a predetermined target flight route that the drone is to cover until reaching a target position in the shaft;
determining an actual flight route of the drone by processing the sensor data, and generating the control signal based on a deviation of the actual flight route from the target flight route; and
wherein the shaft has door regions and/or height markings that are recognized by processing the sensor data, and the actual flight route determined based on the recognized door regions and/or height markings.

15. The method according to claim 14 wherein the actual distances include a first actual distance of the drone relative to the first shaft wall in a first spatial direction and a second actual distance of the drone relative to the second shaft wall in a second spatial direction orthogonal to the first spatial direction, the predetermined target distances include a first target distance and a second target distance, and the control signal is generated based on a deviation of the first actual distance from the first target distance and a deviation of the second actual distance from the second target distance.

16. The method according to claim 15 wherein the actual distances include an additional first actual distance of the drone relative to the first shaft wall in the first spatial direction, the first actual distance and the additional first actual distance being associated with different points of the first shaft wall, an actual orientation of the drone is determined based on the first actual distance and the additional first actual distance, and the control signal is further generated based on a deviation of the actual orientation from a predetermined target orientation.

17. The method according to claim 15 including determining a third actual distance of the drone relative to a ceiling of the shaft by processing the sensor data, and wherein the control signal is further generated based on a deviation of the third actual distance from a predetermined third target distance.

18. The method according to claim 17 including determining a fourth actual distance of the drone relative to a floor of the shaft by processing the sensor data, and wherein the control signal is further generated based on a deviation of the fourth actual distance from a predetermined fourth target distance.

19. The method according to claim 14 including generating measurement data comprising a measured width, depth and/or length of the shaft from the sensor data.

20. The method according to claim 14 including transmitting the sensor data and/or data generated from the sensor data from the control device to an external data processing device.

21. A control device for controlling an actuator system that controls a drone in flight, the drone having a sensor system for detecting an environment and/or a state of the flight of the drone, the control device comprising a processor adapted to perform the method according to claim 14.

22. A drone control system for actuating an actuator system of a drone, the drone control system comprising:
a sensor system detecting an environment and/or a state of a flight of the drone; and
the control device according to claim 21.

23. The drone control system according to claim 22 wherein the sensor system includes an ultrasonic sensor system that detects the environment of the drone and/or a laser sensor system that detects the environment of the drone.

24. The drone control system according to claim 22 wherein the sensor system includes an acceleration sensor system that detects the state of the flight of the drone.

25. An elevator installation comprising:
an elevator shaft having at least a first shaft wall and a second shaft wall adjoining the first shaft wall; and
a drone adapted to be controlled along the elevator shaft, the drone being equipped with an actuator system controlling the drone and a drone control system according to claim 22 actuating the actuator system.

26. A non-transitory computer program comprising commands that cause a processor to carry out the method according to claim 14 when the computer program is executed by the processor.

27. A non-transitory computer-readable medium on which the computer program according to claim 26 is stored.
